(19) United States
(12) Patent Application Publication
(10) Pub. No.: US 2012/0319668 A1
(43) Pub. Date: Dec. 20, 2012

(54) POWER SUPPLY CIRCUIT WITH PROTECTION CIRCUIT

(75) Inventors: YI-XIN TU, Shenzhen City (CN); HAI-QING ZHOU, Shenzhen City (CN); JIN-LIANG XIONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/189,567

(22) Filed: Jul. 25, 2011

(30) Foreign Application Priority Data
Jun. 17, 2011 (CN) 201110163756.4

(51) Int. Cl. G05F 1/618

(52) U.S. Cl. 323/283

(57) ABSTRACT

A power supply circuit includes a pulse width modulation (PWM) controller, a plurality of phase circuits connected to the PWM controller, and a protection circuit connected to the PWM controller and each of the phase circuits. The PWM controller controls all of the phase circuits alternately outputting power supply voltages according to a predetermined sequence, and the protection circuit operates to detect whether the phase circuits work normally. When any one of the phase circuits does not work normally, the protection circuit turns off the PWM controller and all of the phase circuits.

### BACKGROUND

1. Technical Field

The present disclosure relates to power supplies, and particularly to a power supply circuit that includes a protection circuit.

2. Description of Related Art

Many electronic devices use multi-phase power supplies. All phases of a multi-phase power supply can work alternately according to predetermined sequences, to output stable voltages and currents. However, malfunction of such a multi-phase power supply is difficult to detect if one or more phases of the multi-phase power supply malfunctions and other phases still work normally. Therefore, the electronic devices using the multi-phase power supply may still request previous working voltages and current of the electronic devices, and the normal phases need to share workload of the malfunctioning phase(s), such that the multi-phase power supply still outputs the previous voltage and current. Thus, loads of the normal phases of the multi-phase power supply increase, which may further damage the multi-phase power supply.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a circuit diagram of a power supply circuit, according to an exemplary embodiment.

FIG. 2 is a circuit diagram of one embodiment of the protection circuit of the power supply circuit shown in FIG. 1.

### DETAILED DESCRIPTION

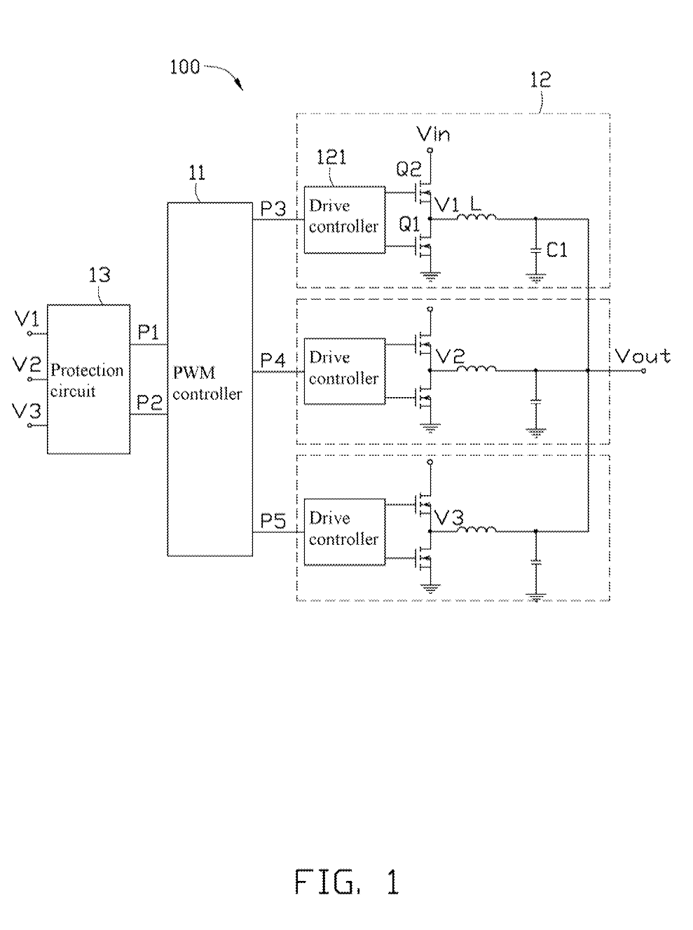

FIG. 1 is a circuit diagram of a power supply circuit 100, according to an exemplary embodiment. The power supply circuit 100 includes a pulse width modulation (PWM) controller 11, a plurality of phase circuits 12 (e.g., the present non-limiting disclosure shows three), and a protection circuit 13. The PWM controller 11 can generate pulse signals to control the phase circuits 12 to alternately output voltages to electronic devices (not shown), thereby supplying power to the electronic devices. The protection circuit 13 detects whether each of the phase circuits 12 works normally, and turn off the PWM controller 11 and all of the phase circuits 12 when any one of the phase circuits 12 malfunctions (i.e., does not work normally).

Each of the phase circuit 12 includes a drive controller 121, a first metal-oxide-semiconductor field-effect transistor (MOSFET) Q1, a second MOSFET Q2, an inductor L, a first capacitor C1, and an input end Vin. In each of the phase circuits 12, the drive controller 121 is connected to gates of both the first MOSFET Q1 and the second MOSFET Q2. A source of the first MOSFET Q1 is grounded, and a drain of the first MOSFET Q1 is connected to a source of the second MOSFET Q2. A drain of the first MOSFET Q1 is connected to the voltage input end Vin. One end of the inductor L is connected to the source of the second MOSFET Q2, and the other end of the inductor L is connected to a ground through the capacitor C1. Furthermore, the source of the second MOSFET Q2 is also used as a detection end, that is, the protection circuit 13 receives a voltage on the source of the second MOSFET Q2 to detect whether the phase circuit 12 works normally. In the present disclosure, the sources of the second MOSFETs Q2 of the three phase circuits 12 are respectively used as the detection ends V1, V2, and V3. All of the phase circuits 12 shares a voltage output end Vout, which is connected to between the inductor L and the first capacitor C1 of each of the phase circuits 12.

The PWM controller 11 includes two enabling pins P1, P2, and a plurality of control pins corresponding to the phase circuits 12 (e.g., the present non-limiting disclosure shows three control pins P3, P4, P5 corresponding the three phase circuits 12). The drive controllers 121 of all of the phase circuits 12 are respectively connected to their corresponding control pins P3, P4, P5. The protection circuit 13 is connected to both the two enabling pins P1, P2. The detection ends V1, V2, and V3 of all of the phase circuits 12 (i.e., the sources of the second MOSFETs Q2 of all of the circuits 12) are connected to the protection circuit 13.

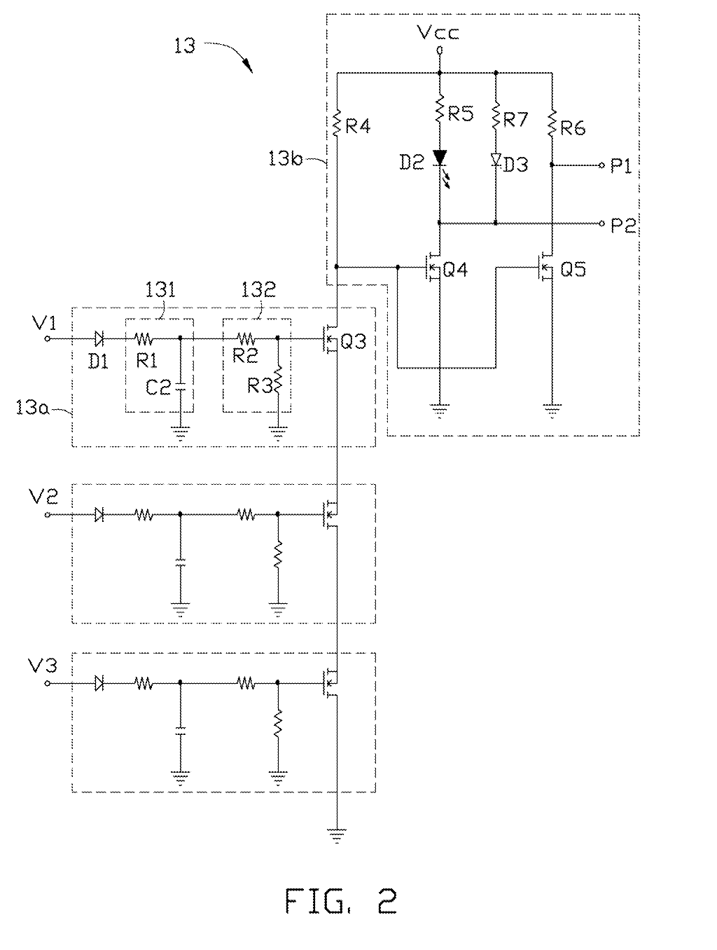

Also referring to FIG. 2, the protection circuit 13 includes a plurality of detection circuits 13a corresponding to the phase circuits 12 (e.g., the present non-limiting disclosure shows three detection circuits 13a) and an enabling circuit 13b. Each of the detection circuits 13a includes a first diode D1, an integrating circuit 131, a bleeder circuit 132, and a third MOSFET Q3. The integrating circuit 131 includes a first resistor R1 and a second capacitor C2, and the bleeder circuit 132 includes a second resistor R2 and a third resistor R3. An anode of the first diode D1 is connected to a detection end V1/V2/V3 corresponding to the detection circuit 13a, and a cathode of the first diode D1 is connected to one end of the first resistor R1. The other end of the first resistor R1 is connected to both one end of the second capacitor C2 and one end of the second resistor R2. The other end of the second capacitor C2 is grounded. The other end of the second resistor R2 is connected to both one end of the third resistor R3 and a gate of the third MOSFET Q3. The other end of the third resistor R3 is grounded. A source of the MOSFET Q3 of the detection circuit 13a that is connected to the detection end V1 is connected to a drain of the MOSFET Q3 of the detection circuit 13a that is connected to the detection end V2. A source of the MOSFET Q3 of the detection circuit 13a that is connected to the detection end V2 is connected to a drain of the MOSFET Q3 of the detection circuit 13a that is connected to the detection end V3. A source of the MOSFET Q3 of the detection circuit 13a that is connected to the detection end V3 is grounded.

The enabling circuit 13b includes an enabling power supply Vcc, a fourth resistor R4, a fifth resistor R5, a sixth resistor R6, a seventh resistor R7, a second diode D2, a fourth MOSFET Q4, and a fifth MOSFET Q5. Each of the fourth resistor R4, the fifth resistor R5, the sixth resistor R6, and the seventh resistor R7 has one end connected to the power supply Vcc. The other end of the fourth resistor R4 is connected to the drain of the third MOSFET Q3, a gate of the fourth MOSFET Q4, and a gate of the fifth MOSFET Q5. The second diode D2 is a light emitting diode (LED). The other end of the fifth resistor R5 is connected to an anode of the second diode D2, and a cathode of the second diode D2 is connected to a drain of the fourth MOSFET Q4. The other end of the sixth resistor R6 is connected to both the enabling pin P1 and a drain of the fifth MOSFET Q5. The other end of the seventh resistor R7 is connected to an anode of the third diode D3. A cathode of the third diode D3 is connected to both the enabling pin P2 and the drain of the fourth MOSFET Q4. Both a source of the fourth MOSFET Q4 and a source of the fifth MOSFET Q5 are grounded.

In use, the PWM controller 11 generates control signals and transmits the control signals to the drive controllers 121 of all of the phase circuits 12 through the control pins P3, P4, P5. In each of the phase circuits 12, upon receiving the control signals, the drive controller 121 turns on the second MOSFET Q2. The voltage input end Vin receives an original voltage of a typical power supply (not shown). The original voltage is transmitted to the source of the second MOSFET Q2, and is further transmitted to the voltage output end Vout through the inductor L. The inductor L and the first capacitor C1 filter alternating current (AC) portions in the original voltage, such that the original voltage is converted to be a desired direct current (DC) voltage when it is transmitted to the voltage output end Vout. In particular, the PWM controller 11 alternately transmits the control signals to the drive controllers 121 of all of the phase circuits 12 according to a predetermined sequence. Thus, the drive controllers 121 of all of the phase circuits 12 alternately turn on the second MOSFETs Q2 of all of the phase circuits 12 according to the predetermined sequence, and the DC voltages generated by all of the phase circuits 12 are alternately transmitted to the voltage output end Vout according to the predetermined sequence and used as power supply voltages for electronic devices (not shown) using the power supply circuit 100. In this way, the power supply circuit 100 is used as a multi-phase power supply.

Furthermore, if the original voltage received by the voltage input end Vin is abnormally high due to malfunction (e.g., being higher than a switch-on voltage of the first MOSFET Q1), the first MOSFET Q1 can be turned on by the original voltage and transmits the original voltage to a ground, such that the power supply circuit 100 is prevented from being damaged by the abnormally high original voltage. In each of the phase circuits 12, the drive controller 121 can also initiatively turns on the first MOSFET Q1 to transmit the original voltage to the ground when the original voltage is identified as being abnormally high.

Since the sources of the second MOSFETs Q2 of the phase circuits 12 are respectively used as the detection ends V1, V2, and V3, when the original voltage is transmitted to the source of the second MOSFETs Q2, it is also transmitted to all of the detection circuits 13a through the detection ends V1, V2, and V3 (i.e., the sources of the second MOSFETs Q2 of all of the circuits 12), respectively. In each of the detection circuits 13a receiving the original voltage, the original voltage turns on the first diode D2, and is transmitted to the gate of the third MOSFET Q3 to turn the third MOSFET Q3 on through the integrating circuit 131 and the bleeder circuit 132. When all of the phase circuits 12 work normally, the original voltage is transmitted to all of the detection circuits 13 through the detection ends V1, V2, and V3, and the third MOSFETs Q3 of all of the detection circuits 13 are turned on. An enabling voltage provided by the enabling power supply Vcc is transmitted to the ground through the fourth resistor R4 and the third MOSFETs Q3, and is unable to turn on the fourth MOSFET Q4 and the fifth MOSFET Q5. Thus, the enabling voltage can also be transmitted to the enabling pin P1 through the sixth resistor R6, and transmitted to the enabling pin P2 through the seventh resistor R7 and the third diode D3. In this way, both the two enabling pins P1 and P2 generate a predetermined logic 1 (e.g., electric levels higher than a predetermined voltage) due to the enabling voltage. The PWM controller 11 is enabled or works normally when it receives the logic 1 on both the two enabling pins P1 and P2.

If any one of the phase circuits 12 malfunctions (i.e., does not work normally), the original voltage received by the voltage input end Vin of the malfunctioning phase circuit 12 is unable to be transmitted to the detection circuits 13a corresponding to the malfunctioning phase circuit 12, and the third MOSFET Q3 of the detection circuits 13a corresponding to the malfunctioning phase circuit 12 is unable to be turned on. Thus, the enabling voltage is unable to be transmitted to the ground through the fourth resistor R4, and thus is applied to the gate of the fourth MOSFET Q4 and the gate of the fifth MOSFET Q5 and turns on the fourth MOSFET Q4 and the fifth MOSFET Q5. When the fourth MOSFET Q4 and the fifth MOSFET Q5 are turned on, the enabling voltages previously provided to the enabling pins P1 and P2 are respectively transmitted to the ground through the turned-on MOSFETs Q5 and Q4. Since the enabling pins P1 and P2 are unable to receive the enabling voltage, both of the enabling pins P1 and P2 generate a predetermined logic 0 (e.g., electric levels lower than a predetermined voltage). Upon receiving the logic 0, the PMW controller 11 is turned off, and all of the phase circuits 12 are correspondingly turned off. In this way, the normal phase circuits 12 are prevented from sharing the workload of the malfunctioning phase circuit 12, and the power supply circuit 100 is protected from being further damaged due to increasing loads of the normal phase circuits 12.

Furthermore, when the fourth MOSFET Q4 is turned on, the cathode of the second diode D2 is connected to the ground through the drain and the source of the MOSFET Q4 (i.e., substantially grounded). Thus, a potential difference between the anode and the cathode of the second diode D2 becomes large enough to drive the second diode D2 to emit light, thereby reminding users to check the power supply 100. When the second capacitors C2 discharge, charges can be transmitted to the ground through the second resistor R2, the third MOSFET(s) Q3, the fourth resistor R4, the seventh resistor R7, the third diode D3, and the fourth MOSFET Q4, such that the PWM controller 11 and the drive controllers 121 are protected from the charges.

The power supply circuit 100 can further include more phase circuits 12. Correspondingly, the PWM controller 11 includes more control pins respectively connected to the drive controllers 121 of the phase circuits 12, and the protection circuit 13 includes more detection circuits 13a respectively connected to the detection ends of the phase circuits 12 (i.e., the sources of the second MOSFETs Q2 of the phase circuits 12). The enabling power supply Vcc is connected to the drain of the third MOSFET Q3 of the first one of the detection circuits 13a through the fourth resistor R4, the source of the third MOSFET Q3 of each previous detection circuit 13a is connected to the drain of the third MOSFET Q3 of a next detection circuit 13a, and the source of the third MOSFET Q3 of the last one of the detection circuits 13a is grounded. In this way, the power supply circuit 100 can be used according to the aforementioned method.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply circuit, comprising:
a pulse width modulation (PWM) controller;
a plurality of phase circuits connected to the PWM controller; and
a protection circuit connected to the PWM controller and each of the phase circuits;
wherein the PWM controller controls all of the phase circuits to alternately output power supply voltages according to a predetermined sequence, and the protection circuit operates to detect whether the phase circuits work normally, and in response to any one of the phase circuits not working normally, the protection circuit turns off the PWM controller and all of the phase circuits.

2. The power supply circuit as claimed in claim 1, wherein each of the phase circuit includes a drive controller, a first metal-oxide-semiconductor field-effect transistor (MOSFET), a second MOSFET, an inductor, a first capacitor, and an input end; the drive controller connected to gates of both the first MOSFET and the second MOSFET, a source of the first MOSFET grounded, a drain of the first MOSFET connected to a source of the second MOSFET, a drain of the second MOSFET connected to the voltage input end, the inductor connected between the source of the second MOSFET and the capacitor, the capacitor connected between the inductor and ground; and in response to the voltage input end receiving an original voltage and the drive controller receiving control signals from the PWM controller, the drive controller turns on the second MOSFET, and the original voltage is transmitted to the source of the second MOSFET and is filtered by the inductor and the first capacitor to be converted to the power supply voltage output by the phase circuit.

3. The power supply circuit as claimed in claim 2, wherein all of the phase circuits share a voltage output end, the voltage output end connected between the inductor and the first capacitor of each of the phase circuits; the power supply voltage output by each of the phase circuits output from the voltage output end.

4. The power supply circuit as claimed in claim 2, wherein when the original voltage is abnormally high, the first MOSFET is turned on and transmits the original voltage to ground.

5. The power supply circuit as claimed in claim 2, wherein the sources of the second MOSFETs of the phase circuits are connected to the protection circuit, and the protection circuit receives the original voltages from the sources of the second MOSFETs of the phase circuits to detect whether the phase circuits work normally.

6. The power supply circuit as claimed in claim 5, wherein the protection circuit includes a plurality of detection circuits corresponding to the phase circuits and a enabling circuit; each of the detection circuits receives the original voltage from the source of the second MOSFET of the phase circuit corresponding to the detection circuit to detect whether the corresponding phase circuit works normally, and the enabling circuit turns off the PWM controller and all of the phase circuits when any one of the phase circuits does not work normally.

7. The power supply circuit as claimed in claim 6, wherein each of the detection circuits includes a third MOSFET, a gate of the third MOSFET receiving the original voltage from the source of the second MOSFET of the phase circuit corresponding to the detection circuit to turn on the third MOSFET; a drain of the third MOSFET of the first one of the detection circuits connected to the enabling circuit, a source of the third MOSFET of each previous phase circuit connected to a drain of the third MOSFET of a next detection circuit, and a source of the third MOSFET of the last one of the detection circuits grounded.

8. The power supply circuit as claimed in claim 7, wherein each of the detection circuits further includes a first diode, an integrating circuit, and a bleeder circuit; an anode of the first diode connected to a source of a second MOSFET of the phase circuit corresponding to the detection circuit to receive the original voltage, and a cathode of the first diode connected to a gate of the third MOSFET through the integrating circuit and the bleeder circuit.

9. The power supply circuit as claimed in claim 7, wherein when any one of the phase circuits malfunctions, the gate of the third MOSFET of the detection circuit corresponding to the malfunctioning phase circuit is unable to receive the original voltage, such that the third MOSFET of the detection circuit corresponding to the malfunctioning phase circuit is turned off, and the enabling circuit turns off the PWM controller and all of the phase circuits upon detecting the turned-off third MOSFET.

10. The power supply circuit as claimed in claim 9, wherein the PWM controller includes two control pins, and the enabling circuit includes an enabling power supply, a fourth MOSFET, and a fifth MOSFET; the drain of the third MOSFET of the first one of the detection circuits, a gate and a drain of the fourth MOSFET, a gate and a drain of the fifth MOSFET are all connected to the enabling power supply, and the two control pins are respectively connected to the drain of the fourth MOSFET and the drain of the fifth MOSFET

11. The power supply circuit as claimed in claim 10, wherein when all of the phase circuits work normally, the original voltage turns on the third MOSFETs of all of the detection circuits, an enabling voltage provided by the enabling power supply is transmitted to the ground through the third MOSFETs of all of the detection circuits, such that the fourth MOSFET and the fifth MOSFET are turned off and the enabling voltage is also transmitted to the two enabling pins to enable the PWM controller.

12. The power supply circuit as claimed in claim 10, wherein when any one of the phase circuits does not work normally and the third MOSFET of the detection circuit corresponding to the phase circuit that does not work normally is turned off, the enabling voltage is unable to be transmitted to the ground and is applied to both the gate of the fourth MOSFET and the gate of the fifth MOSFET to turns on the fourth MOSFET and the fifth MOSFET, such that the enabling voltages for the two enabling pins are respectively transmitted to the ground through the fourth MOSFET and the fifth MOSFET, and the PMW controller and all of the phase circuits are thereby turned off.

13. The power supply circuit as claimed in claim 10, wherein the enabling circuit further includes a second diode connected between the enabling power supply and the drain of the fourth MOSFET; the second diode being a light emitting diode (LED) that emits light when the fourth MOSFET is turned on.

14. The power supply circuit as claimed in claim 10, wherein the enabling circuit further includes a third diode connected between the enabling power supply and the drain of the fourth MOSFET; the third diode used to remove unwanted charges in the power supply circuit.
